(19) United States
(12) Patent Application Publication
(10) Pub. No.: US 2026/0065247 A1
(43) Pub. Date: Mar. 5, 2026

(54) METHODS AND SYSTEMS FOR SEAMLESS INTEGRATION OF PAYMENT PROCESSING INTO E-COMMERCE PLATFORMS

(71) Applicant: OpenPath, Inc., Newport Beach, CA (US)

(72) Inventors: Jason MARTIN, Lake Forest, CA (US); Matthew Joseph Richard WATKINS, Newport Beach, CA (US)

(21) Appl. No.: 19/313,252

(22) Filed: Aug. 28, 2025

Related U.S. Application Data
(60) Provisional application No. 63/688,147, filed on Aug. 28, 2024.

(51) Int. Cl. G06Q 20/20; G06F 9/445; G06F 9/54; G06Q 20/40; G06Q 20/42; G06Q 30/0601

(52) U.S. Cl. CPC G06Q 20/20; G06F 9/44526; G06F 9/54; G06Q 20/4014; G06Q 20/405; G06Q 20/42; G06Q 30/0641

(57) ABSTRACT

Computer-implemented methods and systems are disclosed for processing payment from a customer making a purchase in an online store. Embedded in the online store is an attachable element operable to provide a customer-side graphical user interface. The attachable element is enabled by a merchant application and receives contact information of the customer. Based on contact information from the customer, the customer may be identified as a new customer, and if so, a new user account is automatically created. Otherwise, if the customer is identified and verified as an existing customer, information from the customer's account is retrieved. A payment request from the customer is processed according to one or more rules configured through the merchant application. For example, the system may attempt to process the payment request through an instant payment rail, failing which the system attempts to complete the transaction through an alternative payment processor.

### REFERENCE TO RELATED APPLICATIONS

This application claims priority from U.S. Provisional Patent Application No. 63/688,147 filed on Aug. 28, 2024 entitled “METHODS AND SYSTEMS FOR SEAMLESS INTEGRATION OF PAYMENT PROCESSING INTO E-COMMERCE PLATFORMS”. This application claims the benefit under 35 USC § 119 of U.S. Provisional Patent Application No. 63/688,147 filed on Aug. 28, 2024 entitled “METHODS AND SYSTEMS FOR SEAMLESS INTEGRATION OF PAYMENT PROCESSING INTO E-COMMERCE PLATFORMS”, which is incorporated herein by reference in its entirety.

### TECHNICAL FIELD

The present disclosure relates generally to payment processing systems, and in particular to systems and computer-implemented methods for managing and processing online payments. Some embodiments have example applications for facilitating online store transactions.

### BACKGROUND

Advancements in technology and changes in consumer shopping behavior have led to significant growth in the global electronic commerce (e-commerce) market over the past several years. Today, the term “e-commerce” is used to describe any activity that involves the buying and selling of goods or services online and encompasses a wide range of online business models, including business-to-consumer (B2C), business-to-business (B2B), consumer-to-consumer (C2C), consumer-to-business (C2B), business-to-government (B2G), and government-to-citizen (G2C). Driven by increased digitization and the recent COVID-19 pandemic, global e-commerce sales are now in excess of USD$1 trillion annually and are projected to increase at a steady rate over the next decade.

The continued growth of online consumption calls for continued advancements to online payment processing technology, which is an essential component of a successful e-commerce ecosystem. Such technology includes computer systems and digital platforms that facilitate the transfer of money from a consumer's issuing bank (e.g., from an account, credit line, etc.) to a merchant's acquiring bank, which is required in order to complete any transaction involving goods and/or services purchased online. The systems are normally integrated with e-commerce store checkouts, which are designed to support a wide variety of payment methods, including credit cards, debit cards, electronic wallets (e-wallets), bank transfers, cryptocurrencies, etc., in order to provide flexibility and cater to the preferences of different customers.

Most e-commerce store checkouts currently accept credit card, administered through Visa™, Mastercard™ and other similar payment processing networks, as the primary form of payment. With credit cards, customers must enter their information (e.g., name, card number, and other specifics) each time they complete a purchase. To help expedite the checkout process, some online stores may provide its customers with the option of creating user accounts which store their personal information and card details. When creating a user account, the customer is typically required to select a username for identification and password for authentication. While helpful for repeat customers of the same online store, the account setup process can be tedious for customers who shop across multiple different stores, since it would require the customer to repeat the account creation process for each store.

Wallet-based solutions are available but not widely adopted due to the friction experienced by users when selecting a payment method. For most online stores, it is common practice to integrate the various payment methods available as distinct selectable options, and display the options in a list for the customer to select. Under this practice, the customer is first prompted to select a payment method, is then directed to another page, where the customer is prompted to enter another set of information to identify their payment account (whether it be credit/debit card information, or username and password for a bank account or wallet). The procedure involves multiple steps and tends to slow down the customer's checkout experience.

Regardless of the payment method selected, movement of funds from the customer's issuing bank to the merchant's acquiring bank is currently achieved via credit card network rails, wire transfer, or the asynchronous funding of wallets and allocation of funds to a destination recipient in a separate step. Some of these processes may take up to several days, while others may require manual user steps.

There remains a need for systems and computer-implemented methods which address the abovementioned challenges associated with current payment processing technologies. There remains a need to increase the security of card-initiated transactions by, for example, applying consumer validation steps before accepting payment and/or shifting liability for transactions from the merchant to the consumer. There remains a need for systems and computer-implemented methods which help facilitate the near instantaneous movement of funds from a customer's issuing bank to a merchant's acquiring bank for online retail-related applications. Such systems and computer-implemented methods may be adopted by merchants as an alternative or augmentation to their existing credit card payment services. There remains a need for electronic payment systems that provide merchants with the ability to set their own rules for filtering and routing transactions taking place across multiple online stores or platforms.

### SUMMARY OF THE DISCLOSURE

One aspect of the invention relates to an integrated payment system to support rapid and secure movement of funds from customers to merchants engaged in an online market transaction. The integrated payment system may be provided between an organization's billing platform and their merchant accounts. According to particular embodiments, the system embeds in an online store an attachable element, wherein the attachable element is operable to provide a customer-side graphical user interface (GUI). Contact information of the customer is received through the attachable element when the attachable element is enabled by a merchant application. The merchant application has a merchant-side GUI for interfacing with the online store. The system may process payment information of the customer according to one or more rules configured through the merchant application. Upon processing the payment information, a payment confirmation message may be delivered to the attachable element for display in the customer-side GUI. The payment confirmation message may also be delivered to the merchant application for display in the merchant-side GUI.

In some embodiments, the method provides for streamlined user account creation for a new customer, and does not require an existing customer to enter any payment information or log in to any account during the checkout process. The method includes receiving contact information of the customer through the attachable element, and identifying the customer as a new customer or an existing customer based on the contact information. The contact information may comprise an email address and/or a telephone number. If the customer is identified as a new customer, a new user account may be created automatically and the contact information and the payment information may be automatically associated with the new user account. If the customer is identified as an existing customer, a notification may be delivered to a user device of the customer. The notification may contain one or more prompts for verifying an identity of the customer. The notification may be delivered to the user device via an email address or telephone number provided in the customer's contact information. If the customer is identified and verified as an existing customer, an existing user account of the customer may be accessed to retrieve stored payment information of the customer, and the stored payment information may be delivered to the attachable element for display in the customer-side GUI. The customer may then be prompted to confirm whether the stored payment information should be used as the payment information.

In some embodiments, the method involves identifying whether the payment information is standard payment or instant direct payment as part of the payment information processing. If the payment information is identified as standard payment, the payment information may be routed to a payment gateway or a payment processor. If the payment information is identified as instant direct payment, the method may involve delivering terms and conditions to the attachable element for display in the customer-side GUI. Upon receipt of confirmation of the customer's acceptance of the terms and conditions, the payment information may be routed directly to an issuing bank of the customer.

Another aspect of the invention relates to a system for processing payment information provided by a customer making a purchase in an online store. The system includes a front-end module, a processing module, and a back-end module. The font-end module is configured to provide an attachable element to the online store and a merchant application interfacing with the online store. The attachable element may be enabled by the merchant application and is operable to provide a customer-side graphical user interface (GUI) and receive contact information of the customer when it is enabled. The processing module is configured to process payment information associated with the customer in accordance with one or more rules configured through the merchant application. The back-end module is configured to interface with a receiving bank and payment service providers.

In some embodiments, the front-end module comprises plugins installed directly into the third party platforms powering the online store. In some embodiments, the front-end module comprises an application programing interface (API) configured to allow external systems to connect to the system. In some embodiments, the processing module comprises objects configurable through the merchant application to define the one or more rules. The rules may include authentication rules, filtering rules, and routing rules. In some embodiments, the processing module comprises a global transaction object configured to record the payment information after authentication. In some embodiments, the back-end module comprises connector objects for defining connection specifics to the payment service providers.

In addition to the exemplary aspects and embodiments described above, further aspects and embodiments will become apparent by reference to the drawings and by study of the following detailed descriptions.

### BRIEF DESCRIPTION OF THE DRAWINGS

Features and advantages of the embodiments of the present invention will become apparent from the following detailed description, taken with reference to the appended drawings in which:

FIG. 1 is a schematic illustration of an online retail market environment with an integrated payment system according to an example embodiment.

FIG. 2 is a block diagram of the integrated payment system shown in FIG. 1.

FIG. 3 shows an exemplary logic tree of objects that may be implemented by the

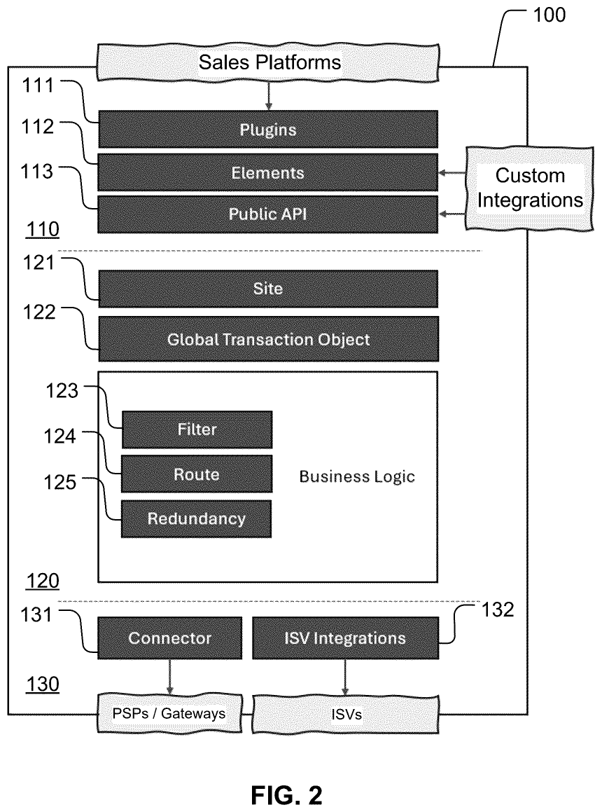

FIG. 2 system to process online payment transactions.

FIG. 4 is a flowchart of a computer-implemented method for processing an online payment.

FIG. 5A is a flowchart of another computer-implemented method for processing an online payment. FIGS. 5B and 5C depict variations of the computer-implemented method shown in FIG. 5A.

FIGS. 6A-6E depict exemplary customer-side graphical user interfaces provided by the FIG. 2 system.

FIGS. 7A-7G depict exemplary merchant-side graphical user interfaces provided by the FIG. 2 system.

### DETAILED DESCRIPTION

The description which follows and the embodiments described therein are provided by way of illustration of examples of particular embodiments of the principles of the present invention. These examples are provided for the purposes of explanation, and not limitation, of those principles and of the invention.

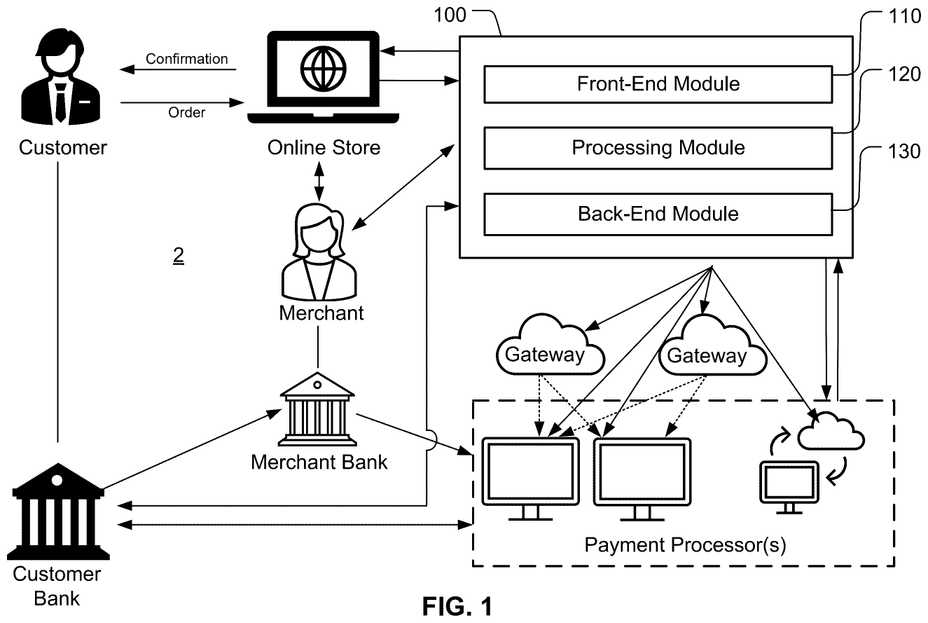

Referring now to FIG. 1, shown therein is a block diagram of an example embodiment of an integrated payment system 100 implemented using one or more computer servers, databases, and network interfaces to facilitate payments from customers to merchants in an online retail market environment 2. In online retail market environment 2, merchants operate online stores to advertise and sell their products or services directly to customers around the world. The online stores may be set up and hosted independently or through a third-party electronic commerce (e-commerce) service provider, such as online marketplaces like Amazon™ and Ebay™ and e-commerce platforms like Shopify™, Wix™, BigCommerce™, and WooCommerce™. The online marketplaces and e-commerce platforms can help provide the technical infrastructure and software tools required for merchants to create and customize their online stores and for customers to visit and make purchases through the stores. For example, some online marketplaces and e-commerce platforms may support features like website hosting, payment processing, inventory management, shipping integration, customer support, etc. Such features allow the merchants to operate their online stores and do business more efficiently.

In a typical transaction taking place in online retail market environment 2, the process begins with a customer visiting, browsing and selecting products or services for purchase in an online store operated by a merchant. After the customer evaluates the selection and confirms their desire to make the purchase, the process proceeds to a checkout step where the customer selects a payment method, and provides their payment information, billing information, and shipping address. Depending on the set-up or configuration of the online store, a wide variety of payment methods may be supported and made available to the customer, including payments through banks (e.g., credit card, debit card, bank transfer, etc.), third party digital wallets (e.g., PayPal™, ApplePay™, etc.), and services provided directly by the platforms powering the online store (e.g., ShopPay™). Some of these payment methods may, optionally, support features that allow customers to create accounts to streamline the checkout process, view order history, track shipments, etc.

Upon completion of the checkout step, the process proceeds to a payment orchestration step where the payment information (provided by the customer) is transmitted to a payment gateway linked to the payment option selected by the customer. The payment gateway serves as a digital equivalent to point-of-sale terminals found in retail stores. The payment gateway encrypts sensitive payment information and transmits the encrypted information to a payment processor. The payment processor is connected to the various financial networks involved in the transaction (e.g., the customer's issuing bank, the merchant's acquiring bank, etc.) and facilitates the transfer of funds from the customer to the merchant. Compared to payment gateways which function as the front-end for receiving the customer's payment information, payment processors function as the back-end for settling funds between the customer and the merchant. In some cases, the payment gateway and the payment processor are provided as part of a combined payment processing service. The payment processing service, in these cases, would be responsible for both handling the payment information and orchestrating the movement of funds.

Upon completion of the payment orchestration step, the process proceeds to a confirmation step where the transaction is confirmed by the payment processor and communicated to the customer and merchant. From the customer's perspective, their order may be confirmed by the online store through an on-screen message and/or other forms of receipt that includes the order details. From the merchant's perspective, the transaction may be confirmed upon receiving notification from the merchant's acquiring bank confirming receipt of funds from the customer's issuing bank.

Depending on the method of payment used by the customer, the payment confirmation step, together with the payment orchestration step, can take up to several days with existing technologies, thereby causing undue delay to merchants who will need to process the order before the transaction can be completed. The problem is worse for merchants who operate multiple online stores, each of which may be powered by different e-commerce platforms, since they may be required to manage multiple payment gateways and processors to reconcile accounts and keep track of the transactions. For example, some payment processors may impose restrictions on merchants operating multiple accounts, while others may charge increased fees for maintaining multiple accounts.

Aspects of the present disclosure relate to an integrated payment system 100 that is specifically configured to support rapid and secure movement of funds from customers to merchants engaged in an online market transaction. The integrated payment system may be provided as a service layer between an organization's billing platform and their merchant accounts (which may be powered by various e-commerce platforms), thereby allowing the merchants to seamlessly manage all of their billing transactions in one platform. As depicted in FIG. 1, a merchant may connect their online store(s) to system 100 which is configured to interface with various existing payment gateways, payment processors, and payment service providers via application programming interfaces (APIs) and secure network protocols. When connected, system 100 executes computer-implemented processes to receive payment information provided by customers through online store(s), filter the payment information, and route the filtered payment information according to factors like customer history, location, etc. Since integrated payment system 100 is connected directly to online stores, some payment information received through the online stores may, in some cases, be routed directly to the issuing bank and/or acquiring banks without passing through any payment gateways, thereby reducing transaction latency and improving security through direct, computer-implemented communication between system 100 and financial institutions.

In the illustrated embodiment, system 100 comprises a front-end module 110, a processing module 120, and a back-end module 130. The modules may be implemented by computing hardware or computers, including servers and dedicated digital processing systems, executing software code. For example, the modules may be implemented as one or more sets of computer-readable instructions stored in a memory device and executable by a processor to provide a wide variety of features that are specifically configured to improve the operation and efficiency of online retail market 2. The features may include those which improve the functionality of e-commerce platforms and ecosystems from the merchant's perspective, such as features which leverage open banking systems to support the instant movement of funds, as well as those which improve the functionality of e-commerce platforms and ecosystems from the customer's perspective, such as features which allow customers to create a validated payment account without disruption to their normal online checkout experience. Some of the features may be provided through or otherwise embodied in the form of attachable elements to the online stores, as discussed in more detail below.

Referring now to FIG. 2, shown therein is a block diagram of an integrated payment system 100 according to an example embodiment. In the illustrated embodiment, system 100 comprises a front-end module 110 configured to interface or interact with one or more sales platforms (e.g., external vendors like Shopify™, WooCommerce™, and Magento™) and custom integrations, a processing module 120 configured to process payment information and other data, and a back-end module 130 configured to interface or interact with payment service providers and gateways (e.g., Stripe™, WorldPay™, FISERV™, Authorize.net™ and Paypal™) and other independent software vendors. In other embodiments, system 100 may comprise additional modules, such as modules configured to interface or interact with billing systems. In general, systems of the type shown in FIG. 2 may be adopted in connection with any platform or system requiring computer-implemented processing of payment card information, including both online and physical point-of-sale systems, thereby providing a unified technical solution for secure and efficient payment processing across various environments.

In the illustrated embodiment, front-end module 110 comprises plugins 111, elements 112, and public application programing interfaces (APIs) 113. Plugins 111 are computer-executable components programmed or otherwise configured to connect system 100 directly to sales platforms, while elements 112 are software modules programmed or otherwise configured to connect system 100 to custom integrations. Plugins 111 may be installed directly into the third party platforms to facilitate automated communication between system 100 and the third party platforms (e.g., allow the third party platforms to send transaction requests to and/or receive completion responses from system 100). Elements 112 may be instantiated in merchant applications and websites to connect the applications and websites to connect to system 100 without requiring extensive software development efforts. In some embodiments, elements 112 allow system 100 to maintain some process sequencing and compliance standards within those components. APIs 113 are programmed or otherwise configured to allow external systems to connect to and operate system 100. APIs 113 allow external parties to complete tasks like sending transaction requests, creating objects within system 100, and querying transaction details. For example, payment information, which may be in the form of a uniform resource locator (URL), may be delivered to system 100 through API 113.

Front-end module 110 may be configured to provide one or more graphical user interfaces (GUI) for users to interact with system 100, including both GUls on the customer side and GUls on the merchant side. The customer-side GUls may be integrated into existing online or mobile checkouts as one or more attachable elements to the checkout interface. The customer-side GUls allow customers to connect to system 100 by, for example, providing their payment information through an online store. FIGS. 6A to 6E show screenshots of an exemplary customer-side GUI that may be provided by system 100.

The merchant-side GUls may be provided through a dedicated application or website. The merchant-side GUls allow merchants to access and connect their online stores to system 100. Through the merchant-side GUls, merchants can configure the logic for processing transaction data and access details of transactions (e.g., information submitted for sale, product information, address information, IP location, demographic information, etc.), connection information to external gateways and payment processors, connection and configuration information for external sales platforms, etc. FIGS. 7A to 7G show screenshots of an exemplary merchant-side GUI that may be provided by system 100.

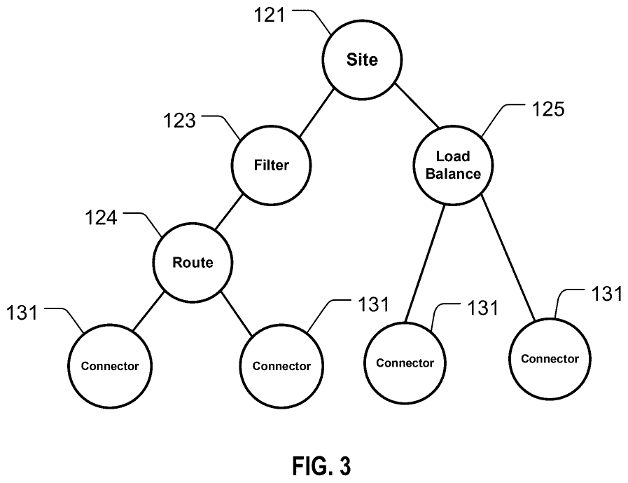

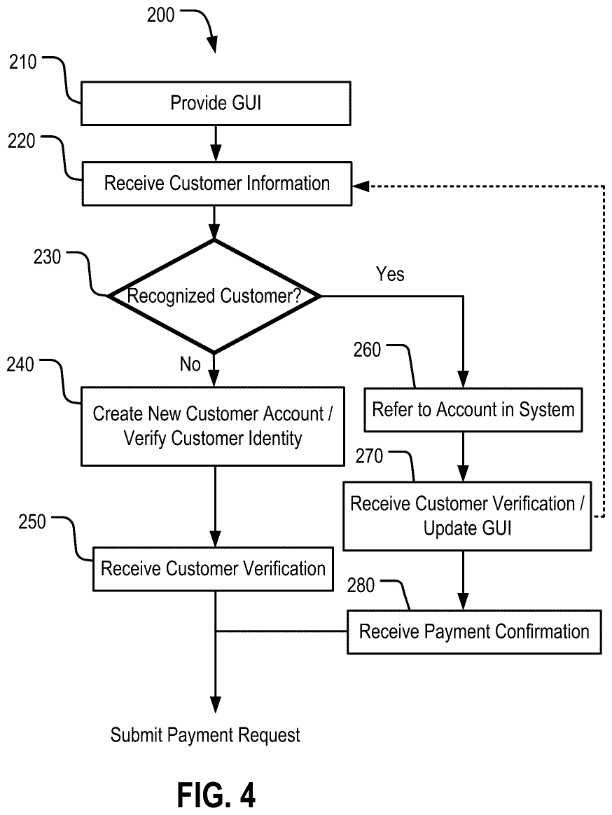

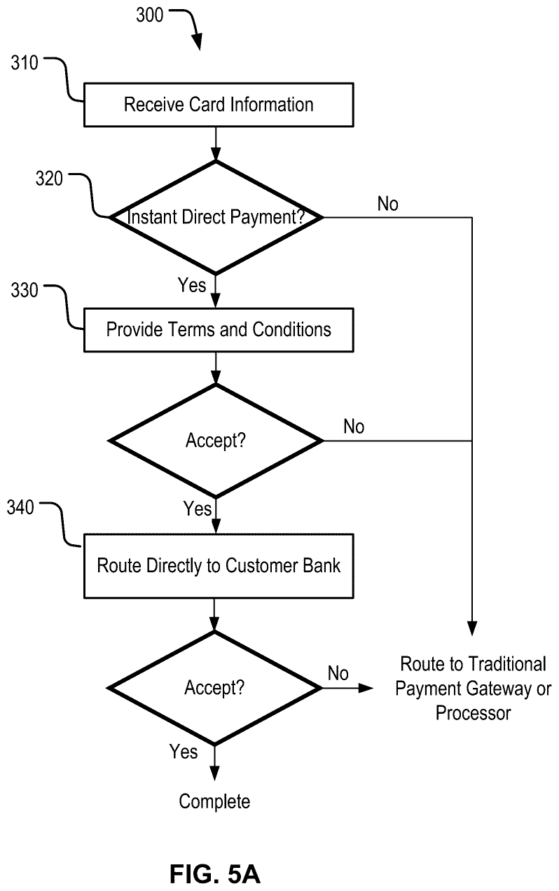

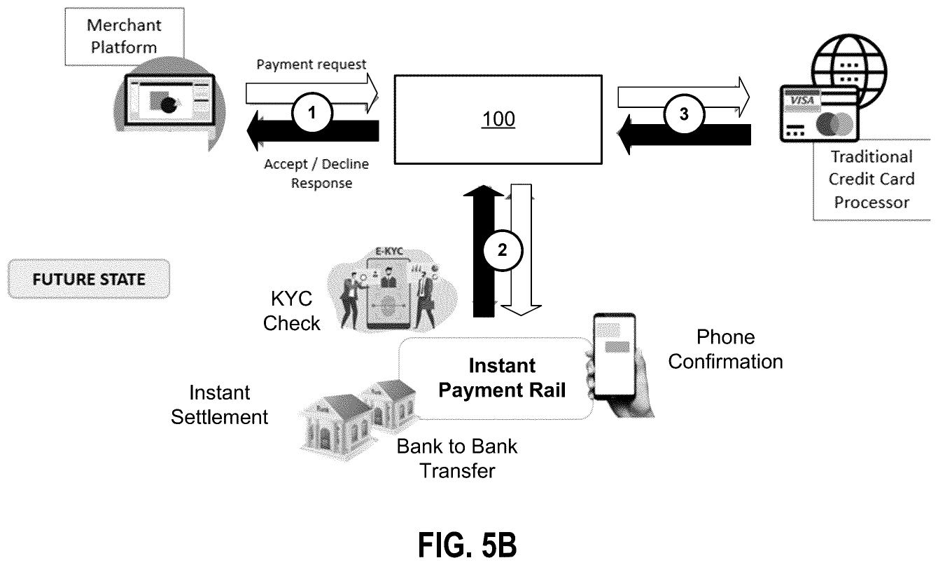

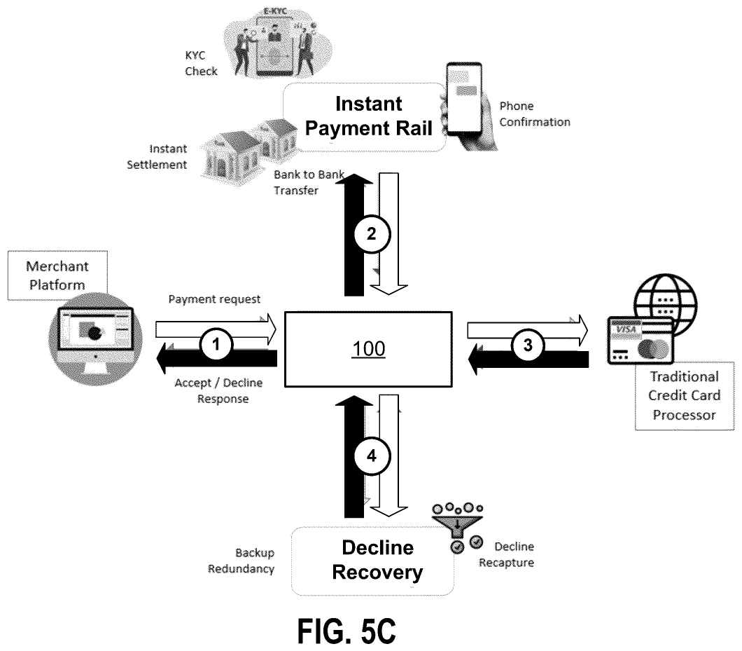

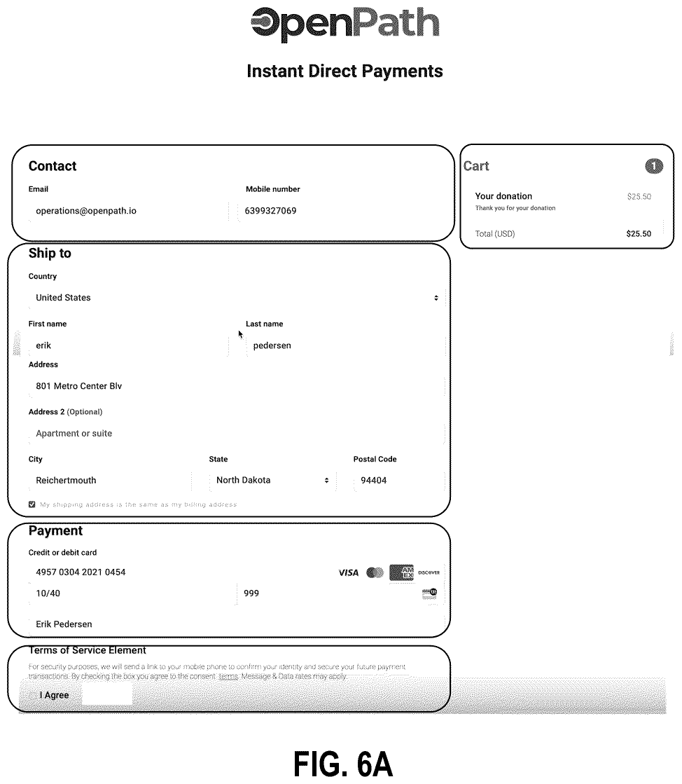

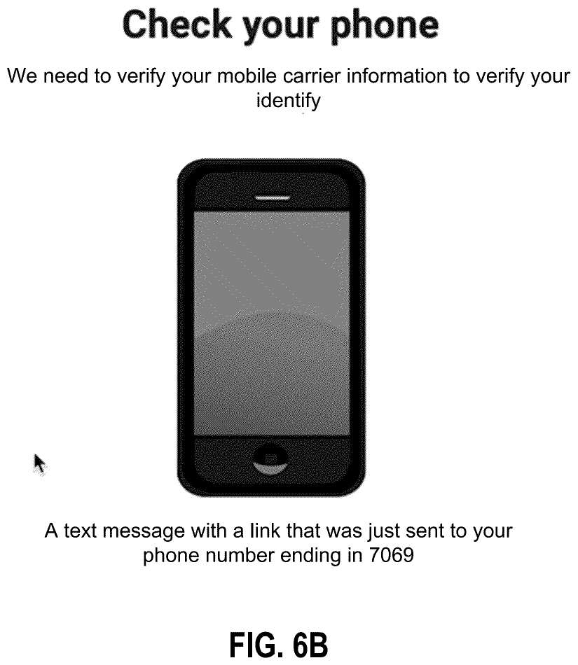

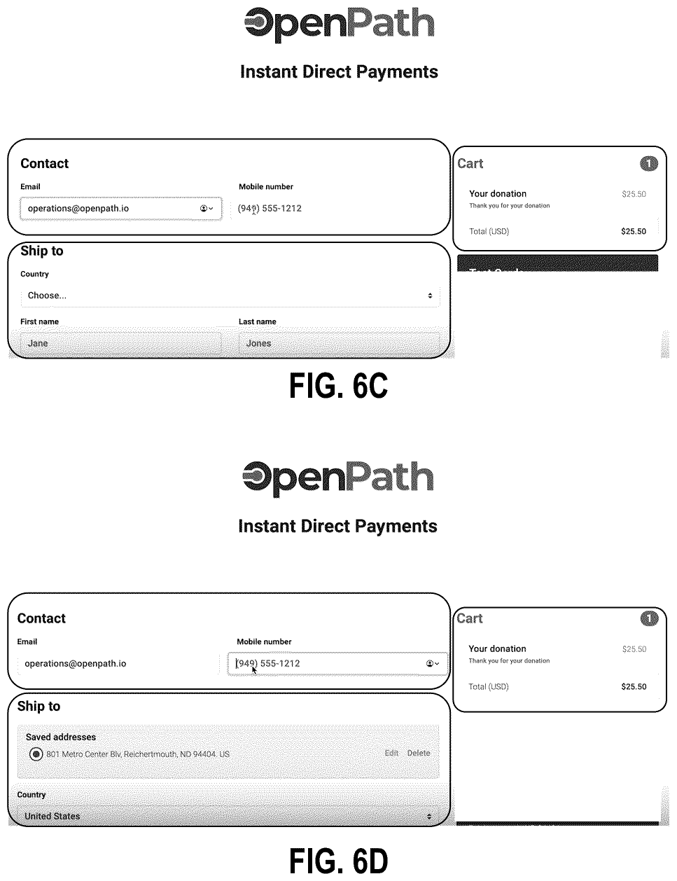

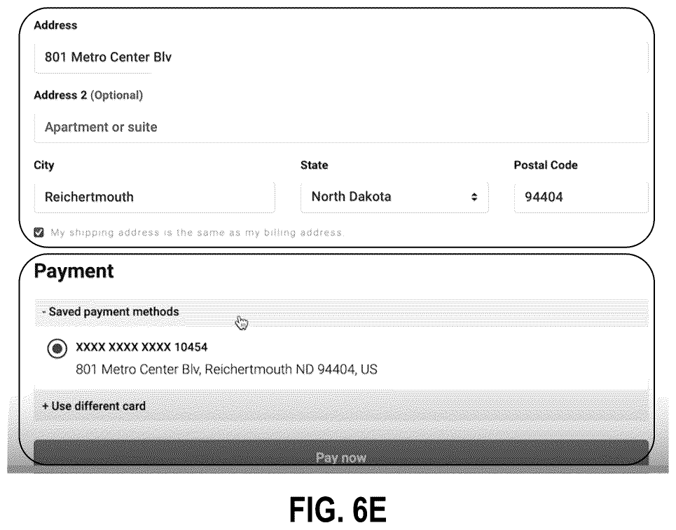

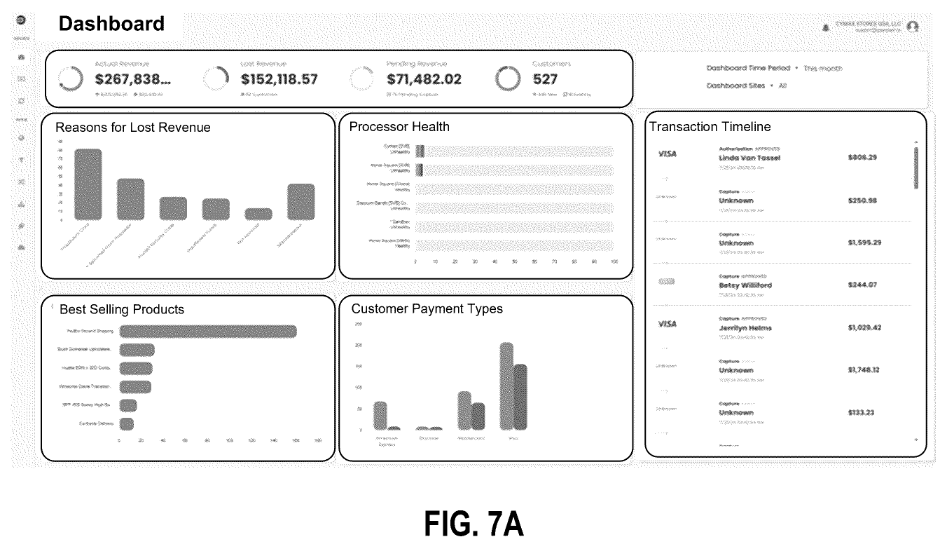

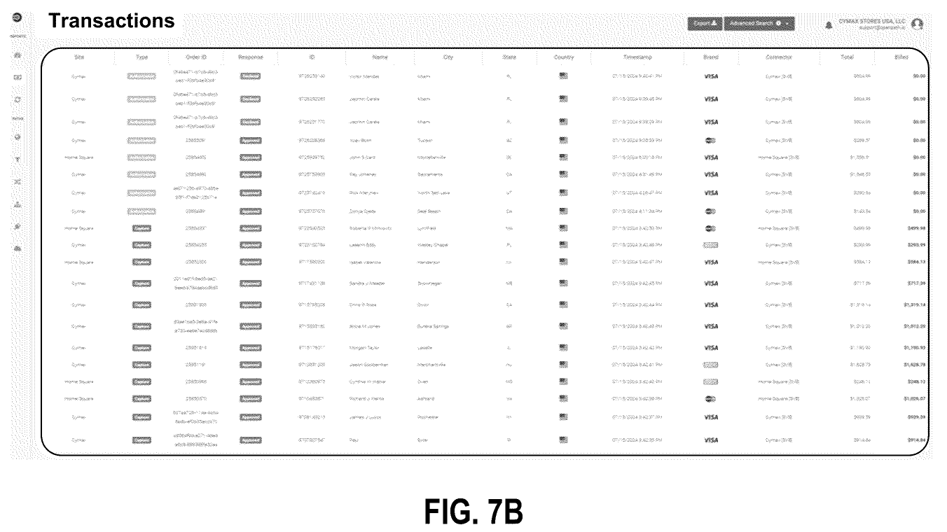

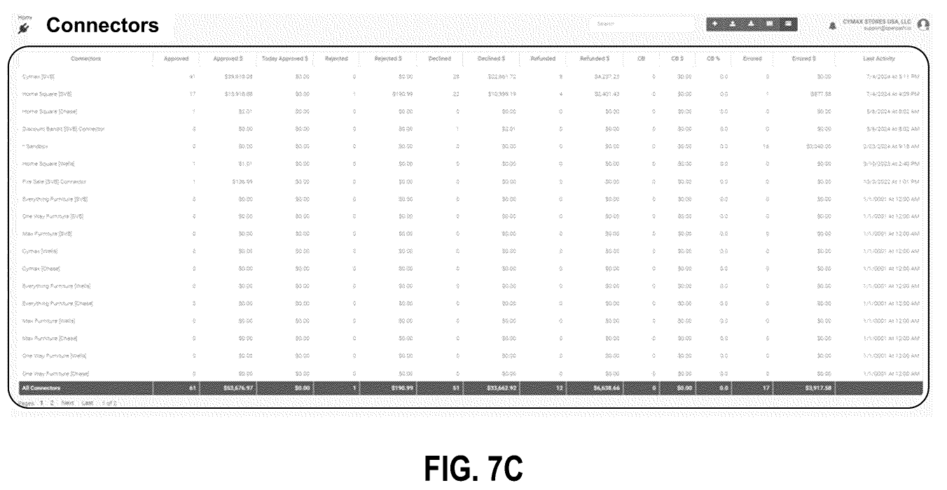

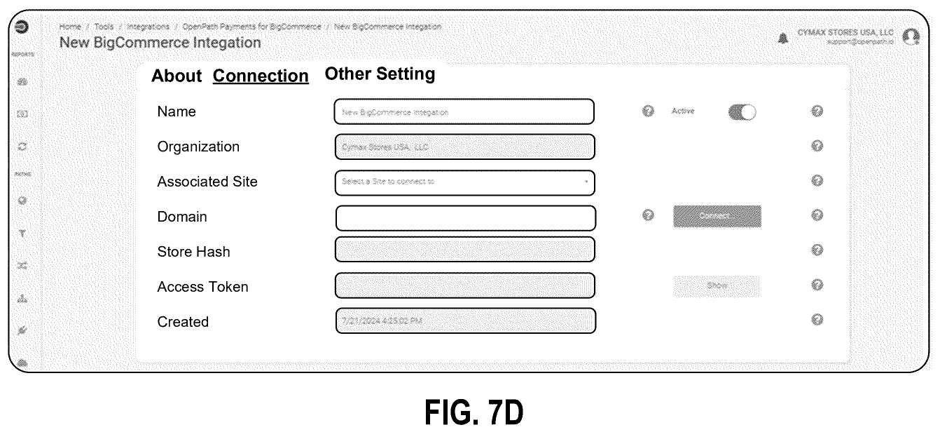

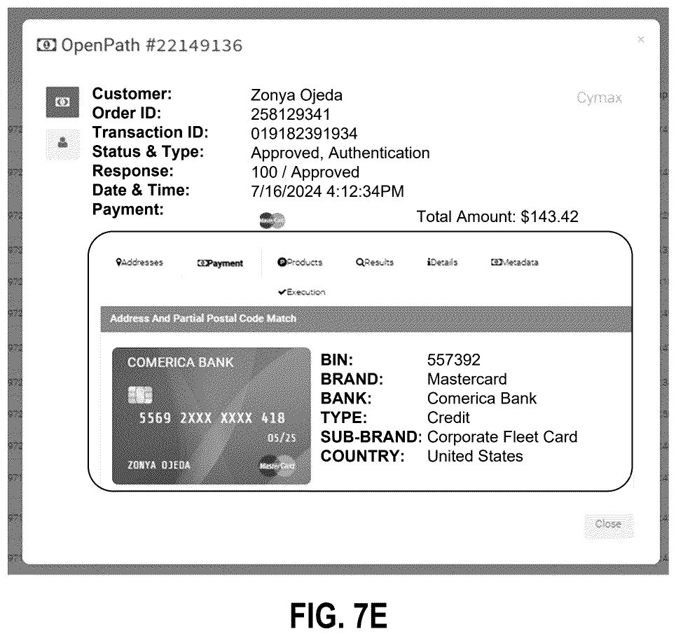

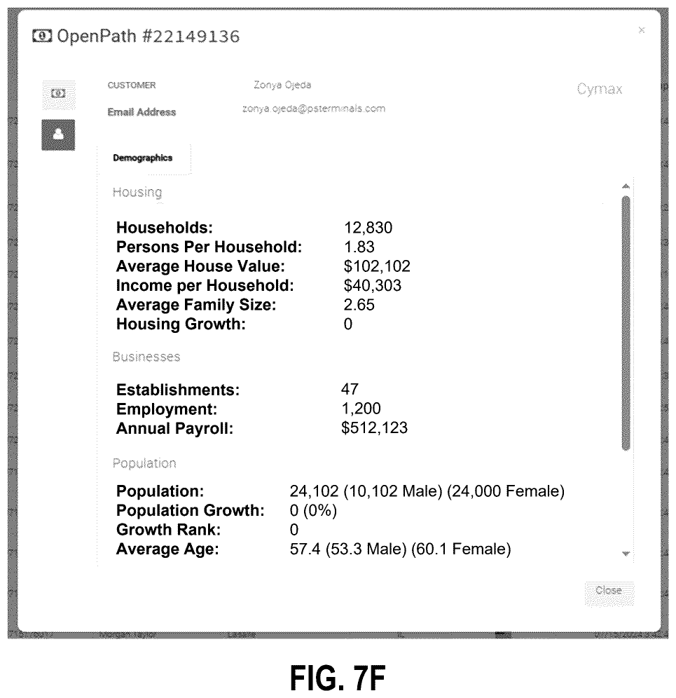

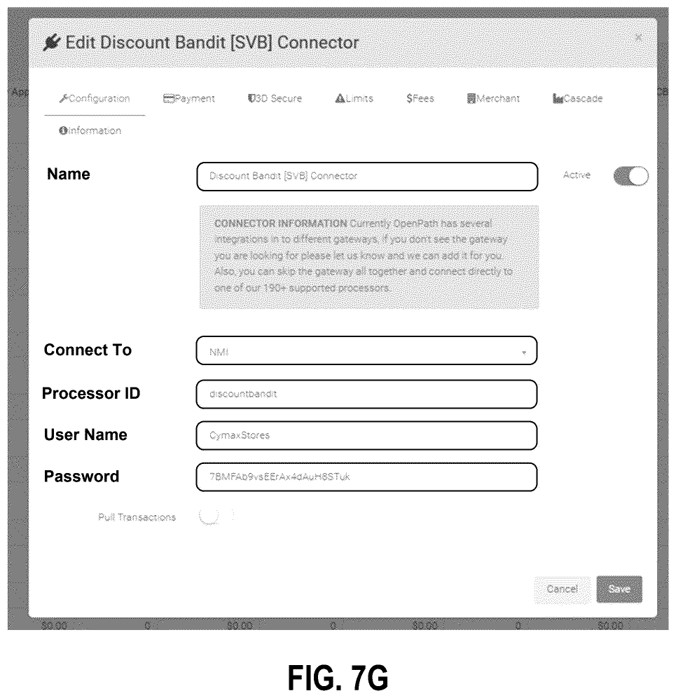

Processing module 120 comprises or otherwise implements software objects or components that are configurable to filter, route and load balance payment information, payment instructions, and other data. The objects may be arranged or otherwise configured in various combinations by the merchant to create one or more logic trees (e.g., see FIG. 3). In general, the root of an object tree comprises a site object 121 which provides or otherwise functions as an entry point into processing module 120 for payment requests received through front-end module 110. In some embodiments, site object 121 serves as a merchant's primary application programming interface (API) behind third party applications (e.g., off-the-shelf billing applications, software as a service (Saas), and customer built applications).

A merchant may set up multiple site objects 121 for their online store(s). For example, a merchant may set up multiple site objects 121 for a single online store. As another example, a merchant operating multiple online store(s) may elect to set up multiple site objects in situations where they wish to manage all the transactions through a single platform while handling each store's transactions independently. The site objects 121 may be set up by the merchant and configured through, for example, a merchant-side GUI provided by front-end module 110.

Each site object 121 may comprise a paths field defining how site object 121 is connected to other objects in processing module 120 or objects in back-end module 130. For example, the paths field of a particular object 121 may be configured by the merchant to define a direct connection between site object 121 and connector object 131, while the paths field of another object 121 may be configured by the merchant to define connection(s) between site object 121 and one or more data flow objects described below. The data flow objects may be programmatically configured or arranged, using software instructions, to process transaction data according to business logic defined by the merchant and executed by the processing module 120.

For a typical payment transaction processed through system 100, the process begins with processing module 120 identifying one or more suitable site objects 121 based on the payment information received through front-end module 110. In some embodiments, processing module 120 is configured to look up site objects 121 by, for example, sub-domain URL to determine which site objects 121 to load. After identifying one or more site objects 121, processing module 120 proceeds to authenticate and determine suitable payment gateways or direct payment rails for handling the incoming payment information. The authenticated payment information is then recorded and, optionally, normalized and converted to one or more global transaction objects 122. Once the payment information has been normalized, processing module 120 selects a suitable path of site object 121 and proceeds to traverse through the data flow objects located along the path.

In the example embodiment shown in FIG. 2, the types of data flow objects supported by processing module 120 include filter objects 123, route objects 124, and redundancy objects 125. Other types or classes of data flow objects are possible and may be supported in other embodiments.

Filter objects 123 are programmed or otherwise configured to block certain payment transactions. Each filter object 123 may comprise a rules field that may be configured by the merchant (e.g., through a merchant-side GUI provided by system 100) to define how transactions should be stopped and returned to site object 121. In some embodiments, the field is predefined with rules that may be enabled or disabled at the discretion of the merchant. In such embodiments, processing module 120 will first determine whether the rules are enabled or disabled when a transaction is passed to filter object 123. The rules may be set up in accordance with logic based on the information received, logic based on historical information recorded for prior transactions, and/or Boolean-based logic. Examples of the types of rules that may be enabled or otherwise implemented by filter objects 123 include, but are not limited to: whether to refuse expired cards, whether to refuse invalid account numbers, whether to refuse transactions which have been previously declined, whether to refuse payment methods with previous chargebacks, and whether to refuse the transaction based on other Boolean logic.

For every rule enabled by the merchant, processing module 120 determines whether the rule is satisfied. This may involve looking up historical transactions associated with the present transaction in some cases. The historical transactions may be stored directly on system 100 or stored somewhere else that is accessible by system 100. If every enabled rule is satisfied by the present transaction, processing module 120 may traverse to the next object defined by the site object path. If a rule is not satisfied by the present transaction, processing module 120 may return to site object 121 and continue by traversing a different path. By incorporating filter objects 123 which decline transactions that fail to meet certain rules or requirements, processing module 120 can increase overall efficiency by reducing the loads and costs on payment gateways and processors that would otherwise have had to handle and reject the transactions that do not meet the requirements.

Route objects 124 are programmed or otherwise configured to direct payment transactions based on logic. Route objects 124 may comprise a rules field that may be configured by the merchant to define how transactions should be redirected. The rules field may be populated with rules that redirect the transaction payment information based on geographical location, IP location, time and date, currency, and/or other transaction data. Some route objects 124 may define a default route which will be taken if other rules are not satisfied. As an example, a route object 124 may be created to account for the transaction's country of origin by implementing the following rules: (i) if the transaction originates from a first country (e.g., United States), processing module 120 shall traverse the logic tree to a first redundancy object 125 (e.g., a North American redundancy object); (ii) if the transaction originates from a second country (e.g., Canada), processing module 120 shall traverse the logic tree to the first redundancy object 125; and (iii) if the transaction originates from anywhere else, processing module shall, by default, traverse the logic tree to a second routing object 124 (e.g., an international routing object).

In some cases, a route object 124 may be connected directly to a connector object 131. By applying different rules to different filter objects 123 and route objects 124, the merchant can control what to do with a transaction based on the current information being processed and/or the history of the customer involved in the transaction.

Redundancy objects 125 are programmed or otherwise configured to select the suitable payment gateway or rails to effect the transaction. Redundancy objects 125 may comprise an algorithm field that may be configured by the merchant to define how a transaction should be automatically distributed to various payment gateways and rails, through connector objects 131, for a balanced load volume. Unlike filter objects 123 and route objects 123 which are configured to define rules, redundancy objects 125 are configured to define algorithms for selecting suitable gateways for processing the payment information. Examples of the types of algorithms that may be enabled or otherwise implemented by redundancy objects 125 include, but are not limited to: a round robin algorithm that cycles through a list of payment gateways in a defined order, a ratio algorithm that cycles through a list of payment gateways in accordance with load balancing ratios assigned to the payment gateways, a daily limit algorithm that selects payment gateways in accordance with their available daily processing volume, a monthly limit algorithm that selects payment gateways in accordance with their available monthly processing volume, a time to respond algorithm, a timing algorithm that selects payment gateways based on the fastest response time, and a risk algorithm that selects payment gateways based on the lowest risk of encountering chargebacks and/or failed payments.

Back-end module 130 comprises connectors 131 and independent software vendor (ISV) integrations 132. Connectors 131 are objects that may be configured to define connection specifics to a payment gateway or payment service provider. In general, each leaf of an object tree comprises a connector 131 which provides or otherwise functions as an exit point out of system 100 for payment requests received through front-end module 110. In the example object tree shown in FIG. 3, site object 121 defines multiple different paths for processing module 120 to traverse through. If processing module 120 is able to traverse through each object provided along a path and reach one of the connectors 131, processing module 120 may cause front-end module 110 to deliver a payment confirmation message to the customer (e.g., through the customer-side GUI).

System 100 may be used to implement one or more methods which improve the functionality of online stores and e-commerce platforms. As an example, system 100 implements methods which increase the security of card-initiated transactions by applying consumer validation steps before accepting payment, thereby shifting some of the potential transaction-related liability from the merchant to the consumer. As another example, system 100 implements methods which support instant direct payments made from a customer's issuing bank to a merchant's acquiring bank. As another example, system 100 implements methods which provide customer-side GUIs that are integrated into existing online stores and e-commerce platforms in the form or one or more attachable elements to support automatic account creation and to expedite the checkout process.

Referring now to FIG. 4, shown therein is a block diagram of a computer-implemented method 200 for processing online payment information according to an example embodiment. Method 200 may be implemented by system 100 or other systems of the type shown in FIG. 2. Method 200 begins with providing a customer-side GUI for receiving customer payment information at step 210. The customer-side GUI may be embedded or otherwise integrated into the existing GUI of an online store or e-commerce platform. The customer-side GUI may be provided as an attachable element to an online store by transmitting instructions to a system powering the online store, wherein the GUI is displayed to customers at checkout when the instructions are executed by a processor of the system. The GUI may include dynamic fields for customers to enter their contact (e.g. email address and/or mobile number), payment, billing, shipping, and other personal information. FIG. 6A shows an example of a customer-side GUI that may be provided at step 210.

After completing step 210, method 200 proceeds to step 220 where payment information and other types of customer information are received by the system. At step 220, the information provided by the customer through the GUI is transmitted to and received by system 100 for data processing. The data processing may include processing which involves business logic and/or decision-making. In the illustrated embodiment, the data received from the online store is processed to determine whether the customer is an existing or returning customer (i.e., someone who has made a purchase through system 100 and/or the GUI provided in step 210) or a new customer (i.e., someone who has never made a purchase through system 100 and/or the GUI provided in step 210) at step 230. The determination may be made based on, for example, contact information provided by the customer completing the checkout process at an online store. The contact information may include an email address and a phone number as shown in FIG. 6A. The system 100 may maintain a database of customer information, and if the provided contact information matches with an email address or phone number in the database, the customer may be identified as an existing customer. The database may also contain other personal information of the customer, such as shipping address, billing address, and payment information.

If it is determined by system 100 at step 230 that the customer is a new customer, method 200 proceeds to step 240. At step 240, system 100 automatically creates an account linking the contact information received at step 220 (e.g., email address and phone number) with other information received at step 240. The other information may include information required to complete the purchase, such as shipping information and payment information. Like the customer's contact information, the other information may be provided by the customer through the GUI as shown in FIG. 6A. In some cases, the GUI also provides a requirement or option for the customer to opt-in to the automatic account creation process. A terms of service agreement may be displayed within the GUI as part of the opt-in option. In these cases, the account creation process may be activated upon system 100 receiving an “opt-in” selection in addition to a “checkout” selection made by the customer through the GUI.

To support automatic account creation, step 240 comprises delivering a notification to the customer for identity verification purposes. As an example, step 240 may comprise delivering an email to the email address provided by the customer through the GUI. As another example, step 240 may comprise delivering a text message to the phone number provided by the customer through the GUI. The text message may include a link for the customer to verify their identify. As part of the checkout and automatic account creation process, the GUI may display a message prompting the customer to check their phone to create their account while completing the checkout. An illustrative example of this type of message is shown in FIG. 6B.

Upon the customer clicking the link or following other instructions set out in the text message, method 200 proceeds to step 250. At step 250, system 100 receives confirmation of the new customer's identity and proceeds to submit the payment request in accordance with other methods described herein.

Referring back to step 230, if it is determined by system 100 that the customer is an existing or returning customer instead of a new customer, method 200 proceeds to step 260 instead of step 240. At step 260, system 100 delivers one or more notifications (e.g., text messages, emails, etc.) to the customer based on the contact information associated with the account stored in system 100. The notifications may be delivered to the customer sequentially to improve security. As an example, system 100 may deliver a first notification to the customer upon determining from information provided in a first contact information field (e.g., email address) that the customer is linked with an account stored in the system. The first notification may be delivered to the customer through the contact information provide in the first field (e.g., email address) or another contact information associated with the account (e.g., phone number). Upon receipt of the first confirmation of identity in step 270, system 100 may retrieve, from the customer database, information associated with the identified customer, and instruct the GUI to display some of the customer's information associated with the account (e.g., shipping address as shown in FIG. 6D). Upon determining from information provided in a second contact information field (e.g., phone address) that the customer is linked with the account, system 100 may deliver a second notification to the customer.

In some cases, method 200 returns to steps 220 and 230 upon completion of step 270 where a second piece of contact information is received and assessed against the accounted stored in system 100. The second notification may be delivered to the customer through the contact information provided in the second field (e.g., phone number) or another contact information associated with the account (e.g., email address). Upon receipt of the second confirmation of identity at step 270, system 100 may retrieve, from the customer database, further information associated with the identified customer, and instruct the GUI to display the remaining customer information associated with the account (e.g., credit or debit card number and billing address as shown in FIG. 6E). If the information is acceptable to the customer, they can provide a confirmation (e.g., by clicking a “pay now” button, etc.) through the GUI and complete the checkout process. Upon the customer providing the confirmation, method 200 proceeds to step 280. At step 280, system 100 receives confirmation of the customer's decision to complete the checkout process and submits and processes the payment request in accordance with the methods described herein (e.g. such as method 300, as described below).

The identity verification process supported by method 200 provides for a simplified checkout experience for an existing (returning) customer. In accordance with the method described herein, the existing customer does not need to enter any payment information or log in to any account during the entire checkout process, as this information can be retrieved by the system 100 upon identifying and verifying the customer as an existing customer. From an existing customer's perspective, their entire checkout experience can be as simple as entering their contact information in one or more contact information fields provided by the GUI and verifying their identity by following the prompts or instructions delivered to their phone or email.

Furthermore, the account creation process supported by method 200 provides for a simplified checkout experience for new customers. In accordance with the method described herein, a new customer does not need to provide or come up with any additional information (e.g., a username, a password, etc.) to become an existing customer recognized by system 100. From a new customer's perspective, their entire account creation experience can be as simple as opting-in to the account creation and verifying their identity by following the prompts or instructions delivered to their phone or email.

In addition, since system 100 is a standalone system, a customer does not need to be an existing customer of an online store in order to be recognized as an existing customer for the purposes of checkout. This is advantageous because it allows customers shopping at new stores to take advantage of their existing account with system 100 for checkout without the need to create new accounts with the new store. When integrated into and across multiple e-commerce platforms, system 100 can improve the platforms' functionality by providing a common means of processing payment through automatically created payment accounts which expedite the checkout process.

Referring now to FIG. 5A, shown therein is a block diagram of a computer-implemented method 300 for processing online payment information according to an example embodiment. Like method 200, method 300 may be implemented by system 100 or other systems of the type shown in FIG. 2. Method 300 may be implemented alone by itself or concurrently with method 200.

Method 300 begins with receiving payment information, including for example credit card or debit card numbers, at step 310. The information may be received through a customer-side GUI provided by system 100 or through the online stores directly. After receiving the payment information, method 300 proceeds to step 320 which comprises determining whether the payment information received at step 310 qualifies as a form of instant direct payment. Qualified forms of instant direct payment may include, for example, bank-to-bank transfer, debit, lonia (formerly CrayPay™), Zelle™, and Venmo™.

If it is determined at step 320 that the payment information received at step 310 does not qualify as a form of instant direct payment, the payment information is routed to a traditional payment gateway or payment processor. Optionally, method 300 may involve delivering a message to the customer confirming whether the payment was approved by the traditional payment gateway or payment process.

If it is determined at step 320 that the payment information received at step 310 qualifies as a form of instant direct payment, method 300 proceeds to step 330. Step 330 comprises providing the customer with the option of submitting the payment information through an instant direct payment system. The option may be provided to the customer by, for example, causing a customer-side GUI provided by system 100 to display certain terms and conditions with an option to accept or decline. If the terms and conditions are not accepted by the customer, then the payment information is routed to the traditional payment gateway or payment processor as shown in FIG. 5A.

If the terms and conditions are accepted by the customer, method 300 proceeds to step 340. Step 340 comprises submitting a payment request containing the payment information to an instant direct system. If the request is not accepted by the instant direct system, then the payment information is routed to the traditional payment gateway or payment processor as shown in FIG. 5A. If the request is accepted by the instant direct system, then the payment information is routed accordingly and the process is complete with the customer's funds moving instantaneously from the customer's issuing bank to the merchant's receiving bank.

In some embodiments, method 300 is configured to automatically try alternative payment processors in situations where a request to a particular payment processor is not successful. The request to a payment processor may not succeed for a variety of reasons (e.g. technical issue, insufficient funds). In such embodiments, different candidate payment processors may be automatically identified and selected by system 100 until the request passes through. For example, a third payment processor may be used in situations where a second payment processor cannot be used, regardless of whether the payment gateways are different or whether the money movement mechanisms are different.

In the example shown in FIG. 5B, system 100 receives a payment request and attempts to process the request through an instant payment rail. If the payment request qualifies, the transaction will be completed through the instant payment rail and a response will be delivered to the customer through the merchant platform. If the payment request does not qualify, system 100 will attempt to complete the transaction through an alternative payment processor such as, for example, a traditional credit card processor. If the alternative payment processor also does not accept the request, system 100 may attempt to complete the transaction through a different alternative processor, such as, for example, a card processor that specializes in accepting previously declined transactions, as shown and referred to as “decline recovery” in FIG. 5C.

The examples and corresponding diagrams used herein are for illustrative purposes only. Different configurations and terminology can be used without departing from the principles expressed herein. For example, unless the context clearly requires otherwise, throughout the description and the claims, the singular forms “a”, “an” and “the” can also include the meaning of any appropriate plural forms, and vice-versa.

The systems and methods described herein are implemented using one or more computing devices, such as servers, client terminals, and networked components, which execute instructions stored on non-transitory computer-readable media. The described systems may, in some cases, utilize dedicated hardware and/or software components to perform operations including, but not limited to, dynamically routing payment requests, monitoring transaction statuses in real time, and automatically selecting among multiple payment service providers based on predefined criteria and real-time data. The various operations described herein may be performed by specifically programmed computing devices, and the order of operations may be varied without departing from the scope of the invention. The invention is not limited to any particular hardware or software configuration, and may be implemented using various suitable combination of computing devices, network infrastructure, and computer-executable instructions.

Although the invention has been described with reference to certain specific embodiments, various modifications thereof will be apparent to those skilled in the art without departing from the scope of the invention. The scope of the claims should not be limited by the illustrative embodiments set forth in the examples, but should be given the broadest interpretation consistent with the description as a whole. For example, various features are described herein as being present in “some embodiments”. Such features are not mandatory and may not be present in all embodiments. Embodiments of the invention may include zero, any one or any combination of two or more of such features. This is limited only to the extent that certain ones of such features are incompatible with other ones of such features in the sense that it would be impossible for a person of ordinary skill in the art to construct a practical embodiment that combines such incompatible features. Consequently, the description that “some embodiments” possess feature A and “some embodiments” possess feature B should be interpreted as an express indication that the inventors also contemplate embodiments which combine features A and B (unless the description states otherwise or features A and B are fundamentally incompatible).

1. A computer-implemented method for processing payment information from a customer making a purchase in an online store, the method comprising:
transmitting instructions to an online store for embedding in the online store an attachable element, wherein the attachable element is configured to provide a customer-side graphical user interface (GUI) rendered on a user device;
receiving contact information of the customer through the attachable element when the attachable element is enabled by a merchant application interfacing with the online store;
obtaining payment information of the customer from a data store or via user input, and processing the payment information according to one or more rules configured through the merchant application; and
upon processing the payment information, delivering a payment confirmation message to the attachable element for display in the customer-side GUI.

2. The method of claim 1, comprising identifying the customer as a new customer or an existing customer based on the contact information of the customer.

3. The method of claim 2, comprising creating a new user account automatically if the customer is identified as a new customer, prompting the customer to provide the payment information through the customer-side GUI, and associating the contact information and the payment information with the new user account.

4. The method of claim 2, comprising delivering a notification to the user device of the customer if the customer is identified as an existing customer, the notification containing one or more prompts for verifying an identity of the customer.

5. The method of claim 4, wherein the notification is delivered to the user device via an email address or telephone number identified in the contact information.

6. The method of claim 4, comprising accessing an existing user account of the customer to retrieve stored payment information of the customer, and delivering the stored payment information to the attachable element for display in the customer-side GUI.

7. The method of claim 6, wherein receiving the payment information comprises receiving a confirmation from the customer to use the stored payment information as the payment information.

8. The method of claim 1, wherein the contact information comprises one or more of: an email address and a telephone number.

9. The method of claim 1, wherein processing the payment information comprises identifying the payment information as standard payment or as instant direct payment.

10. The method of claim 9, comprising routing the payment information to a payment gateway or a payment processor if the payment information is identified as standard payment.

11. The method of claim 9, comprising delivering terms and conditions to the attachable element for display in the customer-side GUI if the payment information is identified as instant direct payment.

12. The method of claim 11, comprising routing the payment information to facilitate payment directly from an issuing bank of the customer upon receiving confirmation of acceptance of the terms and conditions by the customer.

13. The method of claim 1, comprising delivering the payment confirmation message for display in a merchant-side GUI provided by the merchant application.

14. A system for processing payment information provided by a customer making a purchase in an online store, the system comprising:
a front-end module configured to provide an attachable element to the online store and a merchant application interfacing with the online store, the attachable element operable to provide a customer-side graphical user interface (GUI) and receive contact information of the customer when the attachable element is enabled by the merchant application;
a processing module configured to process payment information associated with the customer in accordance with one or more rules configured through the merchant application; and
a back-end module configured to interface with a receiving bank and one or more payment service providers.

15. The system of claim 14, wherein the front-end module comprises computer-implemented plugins installed directly into one or more third party platforms powering the online store.

16. The system of claim 14, wherein the front-end module comprises an application programing interface (API) configured to allow one or more external systems to connect to the system.

17. The system of claim 14, wherein the processing module comprises one or more software objects configurable through the merchant application to define the one or more rules.

18. The system of claim 17, wherein the one or more rules include authentication rules, filtering rules, and routing rules.

19. The system of claim 18, wherein the processing module comprises a global transaction object configured to record the payment information after authentication.

20. The system of claim 14, wherein the back-end module comprises connector objects for defining connection specifics to the one or more payment service providers.
